(19) United States
(12) Patent Application Publication
(10) Pub. No.: US 2026/0074749 A1
(43) Pub. Date: Mar. 12, 2026

(54) PRIORITIZING SPECTRUM EFFICIENCY OVER BUFFER-BASED MULTIPLE INPUT, MULTIPLE OUTPUT COMMUNICATIONS

(71) Applicant: AT&T Intellectual Property I, L.P., Atlanta, GA (US)

(72) Inventors: Jianchun Zhou, Bellevue, WA (US); Yakun Gao, Suwanee, GA (US)

(21) Appl. No.: 18/884,067

(22) Filed: Sep. 12, 2024

(51) Int. Cl. H04B 7/0452

(52) U.S. Cl. CPC H04B 7/0452

(57) ABSTRACT

A method performed by a processing system including at least one processor includes detecting a presence of a plurality of user devices in a cell of a mobile network, wherein each user device of the plurality of user devices includes a buffer of a plurality of buffers, and wherein a fill level of at least one buffer of the plurality of buffers is less than one hundred percent, determining that a spatial separation between the plurality of user devices meets a threshold spatial separation required to support multiple user multiple input, multiple output communications and that a spectrum efficiency for multiple-user multiple input, multiple output communications is higher than a spectrum efficiency for single-user multiple input, multiple output communications, and activating multiple-user multiple input, multiple output communications in the cell for the plurality of user devices.

The present disclosure relates generally to wireless communications and relates more particularly to devices, non-transitory computer-readable media, and methods for prioritizing spectrum efficiency over buffer-based multiple input, multiple output (MIMO) communications.

### BACKGROUND

Multiple input, multiple output (MIMO) communications are typically enabled by increasing the number of antennas on a wireless router so that a single wireless access point can support multiple user endpoint devices simultaneously. Multiple-user MIMO (MU-MIMO) communications reuse the available bandwidth of the wireless router by creating a plurality of individual streams that share the router connection equally, where each stream may be allocated to a different user endpoint device. Fifth Generation (5G) mid-band time division duplexing (TDD) carriers such as n77 can particularly benefit from a unique feature of MU-MIMO communications, which utilizes beamforming in order to allow the entire spectrum to be reused among multiple concurrent user endpoint devices.

### SUMMARY

In one example, the present disclosure describes a device, computer-readable medium, and method for prioritizing spectrum efficiency over buffer-based multiple input, multiple output communications. For instance, in one example, a method performed by a processing system including at least one processor includes detecting a presence of a plurality of user devices in a cell of a mobile network, wherein each user device of the plurality of user devices includes a buffer of a plurality of buffers, and wherein a fill level of at least one buffer of the plurality of buffers is less than one hundred percent, determining that a spatial separation between the plurality of user devices meets a threshold spatial separation required to support multiple user multiple input, multiple output communications and that a spectrum efficiency for multiple-user multiple input, multiple output communications is higher than a spectrum efficiency for single-user multiple input, multiple output communications, and activating multiple-user multiple input, multiple output communications in the cell for the plurality of user devices.

In another example, a non-transitory computer-readable medium stores instructions which, when executed by a processor, cause the processor to perform operations. The operations include detecting a presence of a plurality of user devices in a cell of a mobile network, wherein each user device of the plurality of user devices includes a buffer of a plurality of buffers, and wherein a fill level of at least one buffer of the plurality of buffers is less than one hundred percent, determining that a spatial separation between the plurality of user devices meets a threshold spatial separation required to support multiple user multiple input, multiple output communications and that a spectrum efficiency for multiple-user multiple input, multiple output communications is higher than a spectrum efficiency for single-user multiple input, multiple output communications, and activating multiple-user multiple input, multiple output communications in the cell for the plurality of user devices.

In another example, a device includes a processor and a computer-readable medium storing instructions which, when executed by the processor, cause the processor to perform operations. The operations include detecting a presence of a plurality of user devices in a cell of a mobile network, wherein each user device of the plurality of user devices includes a buffer of a plurality of buffers, and wherein a fill level of at least one buffer of the plurality of buffers is less than one hundred percent, determining that a spatial separation between the plurality of user devices meets a threshold spatial separation required to support multiple user multiple input, multiple output communications and that a spectrum efficiency for multiple-user multiple input, multiple output communications is higher than a spectrum efficiency for single-user multiple input, multiple output communications, and activating multiple-user multiple input, multiple output communications in the cell for the plurality of user devices.

### BRIEF DESCRIPTION OF THE DRAWINGS

The teachings of the present disclosure can be readily understood by considering the following detailed description in conjunction with the accompanying drawings, in which:

FIG. 1 illustrates an example network, or system, in which examples of the present disclosure may operate;

FIG. 2 illustrates a flowchart of an example method for prioritizing spectrum efficiency over buffer-based multiple input, multiple output communications;

FIG. 3 illustrates a chart showing one non-limiting example of how gain can be increased and delay decreased when activating multiple-user multiple input, multiple output communications in a situation where single-user multiple input, multiple output communications would normally be activated;

FIG. 4 illustrates a chart showing one example of how examples of the present disclosure may increase MIMO utilization for both downlink and uplink transmissions; and

FIG. 5 depicts a high-level block diagram of a computing device specifically programmed to perform the functions described herein.

To facilitate understanding, identical reference numerals have been used, where possible, to designate identical elements that are common to the figures.

### DETAILED DESCRIPTION

In one example, the present disclosure prioritizes spectrum efficiency over buffer-based multiple input, multiple output (MIMO) communications. As discussed above, MIMO communications are typically enabled by increasing the number of antennas on a wireless router so that a single wireless access point can support multiple user endpoint devices simultaneously. MU-MIMO communications reuse the available bandwidth of the wireless router by creating a plurality of individual streams that share the router connection equally, where each stream may be allocated to a different user endpoint device. 5G mid-band TDD carriers such as n77 can particularly benefit from a unique feature of MU-MIMO communications, which utilizes beamforming in order to allow the entire spectrum to be reused among multiple concurrent user endpoint devices. Two conditions are typically required for MU-MIMO: (1) sufficient spatial separation of the user endpoint devices; and (2) full data buffers for all user endpoint devices. The first condition is often met naturally; however, the second condition is sometimes difficult to meet due to the bursty nature of the data.

Despite the advantages, current utilization of MU-MIMO in live wireless networks remains relatively low, with an average activation rate of less than twenty percent. This is because many wireless networks favor single-user MIMO (SU-MIMO) over MU-MIMO. In SU-MIMO, a wireless access point sends multiple, simultaneous data streams to one compatible user endpoint device at a time. For instance, when the utilization of radio resources (e.g., number of resource blocks, or RBs) reaches approximately eighty percent, many wireless networks switch to SU-MIMO in time division multiple access (TDMA) mode, rather than MU-MIMO. However, as the network switches to SU-MIMO and different user endpoint devices are scheduled at different transmission time intervals (TTIs), throughput tends to drop and transmission delays tend to increase, negatively impacting the overall spectrum efficiency.

Examples of the present disclosure lower the buffer utilization threshold for MU-MIMO so that when there is sufficient spatial separation between user endpoint devices in a cell, MU-MIMO communications are activated rather than SU-MIMO communications, even if the buffers of the user endpoint devices are not all full. One example, “sufficient” separation is understood to comprise at least approximately fifteen degrees of angular separation on the horizontal direction for downlink (uplink typically does not require separation).

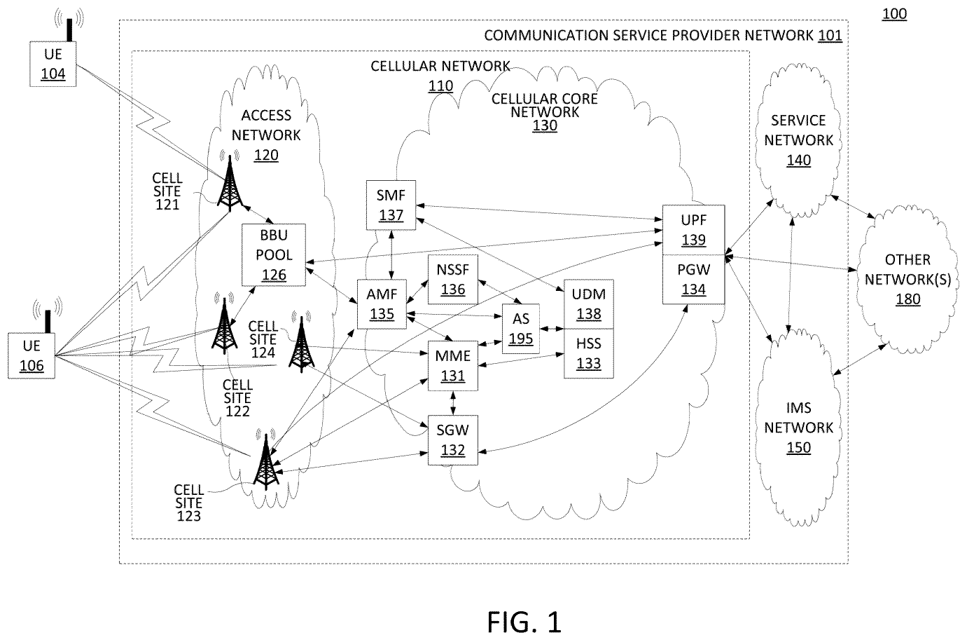

In further examples, for services that are less sensitive to latency, the sizes of the buffers may be increased to allow more data to accumulate in the buffers. This, in turn, will cause non-full-buffer conditions to become full-buffer conditions, which will result in even greater MU-MIMO utilization. Prioritizing MU-MIMO over SU-MIMO will allow a greater number of user endpoint devices to be scheduled for simultaneous data transmissions, which in turn will result in higher throughput, lower latency, and greater overall spectrum efficiency through greater spectrum reuse. These and other aspects of the present disclosure are discussed in greater detail in connection with FIGS. 1-5, below.

FIG. 1 illustrates an example network, or system, 100 in which examples of the present disclosure may operate. In one example, the system 100 includes a communication service provider network 101. The communication service provider network 101 may comprise a cellular network 110 (e.g., a 5G network, a 4G/Long Term Evolution (LTE)/5G hybrid network, or the like), a service network 140, and an IP Multimedia Subsystem (IMS) network 150. The system 100 may further include other networks 180 connected to the communication service provider network 101.

In one example, the cellular network 110 comprises an access network 120 and a cellular core network 130. In one example, the access network 120 comprises a cloud RAN. A cloud RAN, however, is just one example of a RAN with which MU-MIMO may work. MU-MIMO works with all types of RANs, including distributed RANS (D-RANs), centralized RANs (C-RANs), virtualized RANS (V-RANs), and open RANS (O-RANs).

For instance, a cloud RAN is part of the 3GPP 5G specifications for mobile networks. As part of the migration of cellular networks towards 5G, a cloud RAN may be coupled to an Evolved Packet Core (EPC) network until new cellular core networks are deployed in accordance with 5G specifications. In one example, access network 120 may include cell sites 121 and 122 and a baseband unit (BBU) pool 126. In a cloud RAN, radio frequency (RF) components, referred to as remote radio heads (RRHs) or radio units (RUs), may be deployed remotely from baseband units, e.g., atop cell site masts, buildings, and so forth. In one example, the BBU pool 126 may be located at distances as far as 20-80 kilometers or more away from the antennas/remote radio heads of cell sites 121 and 122 that are serviced by the BBU pool 126. It should also be noted in accordance with efforts to migrate to 5G networks, cell sites may be deployed with new antenna and radio infrastructures such as MIMO antennas, and millimeter wave antennas.

Although cloud RAN infrastructure may include distributed RRHs and centralized baseband units, a heterogeneous network may include cell sites where RRH and BBU components remain co-located at the cell site. For instance, cell site 123 may include RRH and BBU components. Thus, cell site 123 may comprise a self-contained “base station.” With regard to cell sites 121 and 122, the “base stations” may comprise RRHs at cell sites 121 and 122 coupled with respective baseband units of BBU pool 126. In one example, baseband unit functionality may be split into a centralized unit (CU) and a distributed unit (DU). In addition, the CU and the DU may be physically separate from one another. For instance, a DU may be situated with an RU/RRH at a cell site, while a CU may be in a centralized location hosting multiple CUs. Alternatively, or in addition, a single CU may serve multiple DUs and/or RUs/RRHs. In accordance with the present disclosure a “base station” may therefore comprise at least a BBU (e.g., in one example, a CU and/or a DU), and may further include at least one RRH/RU.

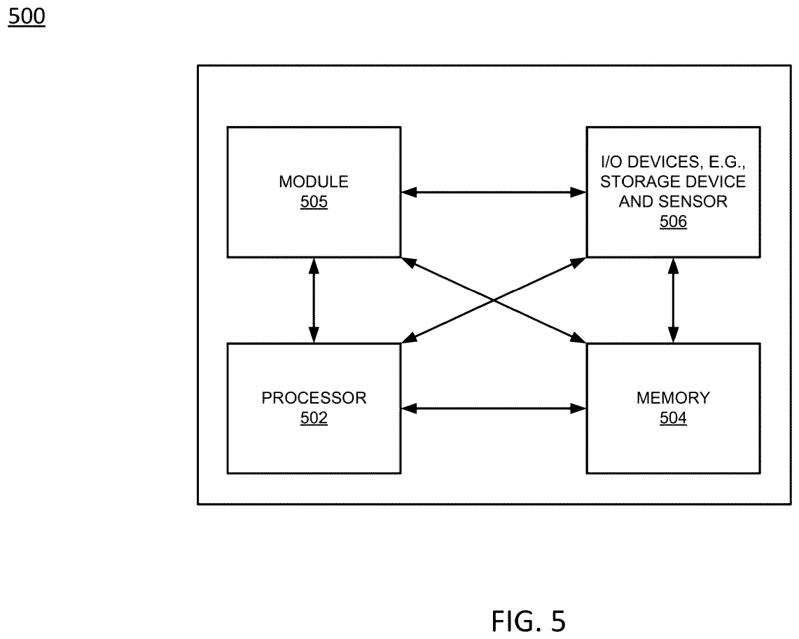

In accordance with the present disclosure, any one or more of cell sites 121-123 may be deployed with antenna and radio infrastructures, including MIMO and millimeter wave antennas. Furthermore, in accordance with the present disclosure, a base station (e.g., cell sites 121-124 and/or baseband units within BBU pool 126) may comprise all or a portion of a computing system, such as computing system 500 as depicted in FIG. 5, and may be configured to perform steps, functions, and/or operations in connection with examples of the present disclosure for activating MU-MIMO for 5G and B5G communications.

In one example, access network 120 may include both 4G/LTE and 5G/NR radio access network infrastructure. For example, access network 120 may include cell site 124, which may comprise 4G/LTE base station equipment, e.g., an eNodeB. In addition, access network 120 may include cell sites comprising both 4G and 5G base station equipment, e.g., respective antennas, feed networks, baseband equipment, and so forth. For instance, cell site 123 may include both 4G and 5G base station equipment and corresponding connections to 4G and 5G components in cellular core network 130. Although access network 120 is illustrated as including both 4G and 5G components, in another example, 4G and 5G components may be considered to be contained within different access networks. Nevertheless, such different access networks may have a same wireless coverage area, or fully or partially overlapping coverage areas.

In one example, the cellular core network 130 provides various functions that support wireless services in the LTE environment. In one example, cellular core network 130 is an Internet Protocol (IP) packet core network that supports both real-time and non-real-time service delivery across a LTE network, e.g., as specified by the 3GPP standards. In one example, cell sites 121 and 122 in the access network 120 are in communication with the cellular core network 130 via baseband units in BBU pool 126.

In cellular core network 130, network nodes such as Mobility Management Entity (MME) 131 and Serving Gateway (SGW) 132 support various functions as part of the cellular network 110. For example, MME 131 is the control node for LTE access network components, e.g., eNodeB aspects of cell sites 121-123. In one embodiment, MME 131 is responsible for UE (User Equipment) tracking and paging (e.g., such as retransmissions), bearer activation and deactivation process, selection of the SGW, and authentication of a user. In one embodiment, SGW 132 routes and forwards user data packets, while also acting as the mobility anchor for the user plane during inter-cell handovers and as an anchor for mobility between 5G, LTE and other wireless technologies, such as 2G and 3G wireless networks.

In addition, cellular core network 130 may comprise a Home Subscriber Server (HSS) 133 that contains subscription-related information (e.g., subscriber profiles), performs authentication and authorization of a wireless service user, and provides information about the subscriber's location. The cellular core network 130 may also comprise a packet data network (PDN) gateway (PGW) 134 which serves as a gateway that provides access between the cellular core network 130 and various packet data networks (PDNs), e.g., service network 140, IMS network 150, other network(s) 180, and the like.

The foregoing describes long term evolution (LTE) cellular core network components (e.g., EPC components). In accordance with the present disclosure, cellular core network 130 may further include other types of wireless network components e.g., 5G network components, 3G network components, etc. Thus, cellular core network 130 may comprise an integrated network, e.g., including any two or more of 2G-5G infrastructures and technologies (or any future infrastructures and technologies to be deployed, e.g., 6G), and the like. For example, as illustrated in FIG. 1, cellular core network 130 further comprises 5G components, including: an access and mobility management function (AMF) 135, a network slice selection function (NSSF) 136, a session management function (SMF) 137, a unified data management function (UDM) 138, and a user plane function (UPF) 139.

In one example, AMF 135 may perform registration management, connection management, endpoint device reachability management, mobility management, access authentication and authorization, security anchoring, security context management, coordination with non-5G components, e.g., MME 131, and so forth. NSSF 136 may select a network slice or network slices to serve an endpoint device, or may indicate one or more network slices that are permitted to be selected to serve an endpoint device. For instance, in one example, AMF 135 may query NSSF 136 for one or more network slices in response to a request from an endpoint device to establish a session to communicate with a PDN. The NSSF 136 may provide the selection to AMF 135, or may provide one or more permitted network slices to AMF 135, where AMF 135 may select the network slice from among the choices. A network slice may comprise a set of cellular network components, such as AMF(s), SMF(s), UPF(s), and so forth that may be arranged into different network slices which may logically be considered to be separate cellular networks. In one example, different network slices may be preferentially utilized for different types of services. For instance, a first network slice may be utilized for sensor data communications, Internet of Things (IoT), and machine-type communication (MTC), a second network slice may be used for streaming video services, a third network slice may be utilized for voice calling, a fourth network slice may be used for gaming services, and so forth.

In one example, SMF 137 may perform endpoint device IP address management, UPF selection, UPF configuration for endpoint device traffic routing to an external packet data network (PDN), charging data collection, quality of service (QoS) enforcement, and so forth. UDM 138 may perform user identification, credential processing, access authorization, registration management, mobility management, subscription management, and so forth. As illustrated in FIG. 1, UDM 138 may be tightly coupled to HSS 133. For instance, UDM 138 and HSS 133 may be co-located on a single host device, or may share a same processing system comprising one or more host devices. In one example, UDM 138 and HSS 133 may comprise interfaces for accessing the same or substantially similar information stored in a database on a same shared device or one or more different devices, such as subscription information, endpoint device capability information, endpoint device location information, and so forth. For instance, in one example, UDM 138 and HSS 133 may both access subscription information or the like that is stored in a unified data repository (UDR) (not shown).

UPF 139 may provide an interconnection point to one or more external packet data networks (PDN(s)) and perform packet routing and forwarding, QoS enforcement, traffic shaping, packet inspection, and so forth. In one example, UPF 139 may also comprise a mobility anchor point for 4G-to-5G and 5G-to-4G session transfers. In this regard, it should be noted that UPF 139 and PGW 134 may provide the same or substantially similar functions, and in one example, may comprise the same device, or may share a same processing system comprising one or more host devices.

It should be noted that other examples may comprise a cellular network with a “non-stand alone” (NSA) mode architecture where 5G radio access network components, such as a “new radio” (NR), “gNodeB” (or “gNB”), and so forth are supported by a 4G/LTE core network (e.g., an EPC network), or a 5G “standalone” (SA) mode point-to-point or service-based architecture where components and functions of an EPC network are replaced by a 5G core network (e.g., a “5GC”). For instance, in non-standalone (NSA) mode architecture, LTE radio equipment may continue to be used for cell signaling and management communications, while user data may rely upon a 5G new radio (NR), including millimeter wave communications, for example. However, examples of the present disclosure may also relate to a hybrid, or integrated 4G/LTE-5G cellular core network such as cellular core network 130 illustrated in FIG. 1. In this regard, FIG. 1 illustrates a connection between AMF 135 and MME 131, e.g., an “N26” interface which may convey signaling between AMF 135 and MME 131 relating to endpoint device tracking as endpoint devices are served via 4G or 5G components, respectively, signaling relating to handovers between 4G and 5G components, and so forth.

In one example, service network 140 may comprise one or more devices for providing services to subscribers, customers, and or users. For example, communication service provider network 101 may provide a cloud storage service, web server hosting, and other services. As such, service network 140 may represent aspects of communication service provider network 101 where infrastructure for supporting such services may be deployed. In one example, other networks 180 may represent one or more enterprise networks, a circuit switched network (e.g., a public switched telephone network (PSTN)), a cable network, a digital subscriber line (DSL) network, a metropolitan area network (MAN), an Internet service provider (ISP) network, and the like. In one example, the other networks 180 may include different types of networks. In another example, the other networks 180 may be the same type of network. In one example, the other networks 180 may represent the Internet in general. In this regard, it should be noted that any one or more of service network 140, other networks 180, or IMS network 150 may comprise a packet data network (PDN) to which an endpoint device may establish a connection via cellular core network 130 in accordance with the present disclosure.

In one example, any one or more of the components of cellular core network 130 may comprise network function virtualization infrastructure (NFVI), e.g., SDN host devices (i.e., physical devices) configured to operate as various virtual network functions (VNFs), such as a virtual MME (vMME), a virtual HHS (vHSS), a virtual serving gateway (vSGW), a virtual packet data network gateway (vPGW), and so forth. For instance, MME 131 may comprise a vMME, SGW 132 may comprise a vSGW, and so forth. Similarly, AMF 135, NSSF 136, SMF 137, UDM 138, and/or UPF 139 may also comprise NFVI configured to operate as VNFs. In addition, when comprised of various NFVI, the cellular core network 130 may be expanded (or contracted) to include more or less components than the state of cellular core network 130 that is illustrated in FIG. 1. It should be noted that intermediate devices and links between MME 131, SGW 132, cell sites 121-124, PGW 134, AMF 135, NSSF 136, SMF 137, UDM 138, and/or UPF 139, and other components of system 100 are also omitted for clarity, such as additional routers, switches, gateways, and the like.

FIG. 1 also illustrates various endpoint devices, e.g., user equipment (UE) 104 and 106. Each of the UEs 104 and 106 may comprise a cellular telephone, a smartphone, a tablet computing device, a laptop computer, a pair of computing glasses, a wireless enabled wristwatch, a wireless transceiver for a fixed wireless broadband (FWB) deployment, or any other cellular-capable mobile telephony and computing device (broadly, “an endpoint device”). For instance, each of the UEs 104 and 106 may include one or more radio frequency (RF) transceivers for cellular communications and/or for non-cellular wireless communications. In one example, each of the UEs 104 and 106 may be equipped with one or more directional antennas, or antenna arrays (e.g., having a half-power azimuthal beamwidth of 120 degrees or less, 90 degrees or less, 60 degrees or less, etc.), e.g., MIMO antenna(s) to receive and/or to transmit multi-path and/or spatial diversity signals.

In one example, each of the UEs 104 and 106 may comprise all or a portion of a computing system, such as computing system 500 depicted in FIG. 5, and may be configured to perform steps, functions, and/or operations in connection with examples of the present disclosure for prioritizing spectrum efficiency over buffer-based MIMO communications. In this regard, it should be noted that as used herein, the terms “configure,” and “reconfigure” may refer to programming or loading a processing system with computer-readable/computer-executable instructions, code, and/or programs, e.g., in a distributed or non-distributed memory, which when executed by a processor, or processors, of the processing system within a same device or within distributed devices, may cause the processing system to perform various functions. Such terms may also encompass providing variables, data values, tables, objects, or other data structures or the like which may cause a processing system executing computer-readable instructions, code, and/or programs to function differently depending upon the values of the variables or other data structures that are provided. As referred to herein a “processing system” may comprise a computing device including one or more processors, or cores (e.g., as illustrated in FIG. 5 and discussed below) or multiple computing devices collectively configured to perform various steps, functions, and/or operations in accordance with the present disclosure.

As illustrated in FIG. 1, UE 104 may access wireless services via the cell site 121 (e.g., NR alone, where cell site 121 comprises a gNB), while UE 106 may access wireless services via any of the cell sites 121-124 located in the access network 120 (e.g., for NR non-dual connectivity, for LTE non-dual connectivity, for NR-NR DC, for LTE-LTE DC, for EN-DC, and/or for NE-DC). For instance, in one example, UE 106 may establish and maintain connections to the cellular core network 130 via one or multiple gNBs (e.g., cell sites 121 and 122 and/or cell sites 121 and 122 in conjunction with BBU pool 126 and/or various other components, such as a CU and/or a DU). In another example, UE 106 may establish and maintain connections to the cellular core network 130 via a gNB (e.g., cell site 122 and/or cell site 122 in conjunction with BBU pool 126) and an eNodeB (e.g., cell site 124), respectively. In addition, either the gNB or the eNodeB may comprise a PCell, and the other may comprise a SCell for carrier aggregation and/or dual connectivity. Similarly, UE 106 may communicate with any of the cell sites 121 and 122 using carrier aggregation (CA) (e.g., in accordance with a CA technique). Furthermore, either or both of NR/5G and or EPC (4G/LTE) core network components may manage the communications between UE 106 and the cellular network 110 via cell site 122 and cell site 124.

In one example, UE 106 may also utilize different antenna arrays for 4G/LTE and 5G/NR, respectively. For instance, 5G antenna arrays may be arranged for beamforming in a frequency band designated for 5G high data rate communications. For instance, the antenna array for 5G may be designed for operation in a frequency band between 1 GHz and 7.125 GHz. In contrast, an antenna array for 4G may be designed for operation in a frequency band less than 5 GHz, e.g., 500 MHz to 3 GHz. In addition, in one example, the 4G antenna array (and/or the RF or baseband processing components associated therewith) may not be configured for and/or be capable of beamforming. Accordingly, in one example, UE 106 may turn off a 4G/LTE radio, and may activate a 5G radio to send a request to activate a 5G session to cell site 122 (e.g., when it is chosen to operate in a non-DC mode or an intra-RAT dual connectivity mode), or may maintain both radios in an active state for multi-radio (MR) dual connectivity (MR-DC).

In accordance with the present disclosure, UE 106 may attach to any cell (e.g., a cell site/base station) of access network 120 and may provide an identification and an indication of a UE type to the cellular network 110. Where the UE 106 and/or any other UEs in the cell are determined to have sufficient spatial separation and at least one of the UEs has a buffer fill level than is less than one hundred percent, the cell (e.g., the base station(s) supporting the cell) may activate MU-MIMO for the UE 106 and/or other UEs in the cell instead of SU-MIMO or other types of communications. Activating MU-MIMO may involve modifying a configuration of the base station(s) and/or UEs to disable certain capabilities and enable other capabilities. For instance, the base station(s) may send instructions to the UEs to activate 5G radios and enable MU-MIMO capabilities. “Sufficient” separation within this context is understood to comprise at least approximately fifteen degrees of angular separation on the horizontal direction for downlink (uplink typically does not require separation).

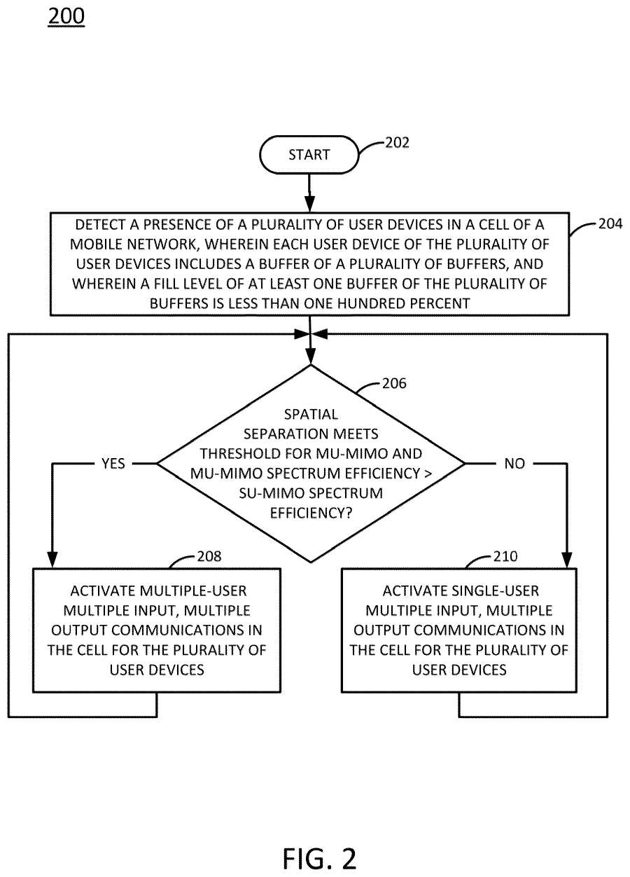

It should be noted that examples of the present disclosure as described herein primarily in connection with steps, functions, and/or operations that are performed by a cellular base station. For instance, FIG. 2 illustrates a flowchart of an example method that may be performed by a serving cell (e.g., a base station and/or any one or more components thereof). However, in other, further, and different examples, various steps, functions, and/or operations as described in connection with FIG. 2, or as described elsewhere herein, may alternatively or additionally be performed by one or more other components. For instance, various steps, functions, and/or operations may alternatively or additionally be performed by a processing system in cellular core network 130, such as application server (AS) 195, AMF 135, SMF 137, MME 131, or the like. To illustrate, in an example in which the foregoing is performed by a base station/cell site, the transmitting of the at least one instruction may be via the base station/cell site to UE 106. However, in an example in which the foregoing may be performed by AS 195, AMF 135, SMF 137, MME 131, or the like, the instruction may be to a cell sites/base station serving UE 106 to activate uplink MU-MIMO communications.

The foregoing description of the system 100 is provided as an illustrative example only. In other words, the example of system 100 is merely illustrative of one network configuration that is suitable for implementing examples of the present disclosure. As such, other logical and/or physical arrangements for the system 100 may be implemented in accordance with the present disclosure. For example, the system 100 may be expanded to include additional networks, such as network operations center (NOC) networks, additional access networks, and so forth. The system 100 may also be expanded to include additional network elements such as border elements, routers, switches, policy servers, security devices, gateways, a content distribution network (CDN) and the like, without altering the scope of the present disclosure. In addition, system 100 may be altered to omit various elements, substitute elements for devices that perform the same or similar functions, combine elements that are illustrated as separate devices, and/or implement network elements as functions that are spread across several devices that operate collectively as the respective network elements.

For instance, in one example, the cellular core network 130 may further include a Diameter routing agent (DRA) which may be engaged in the proper routing of messages between other elements within cellular core network 130, and with other components of the system 100, such as a call session control function (CSCF) (not shown) in IMS network 150. In another example, the NSSF 136 may be integrated within the AMF 135. In addition, cellular core network 130 may also include additional 5G NG core components, such as: a policy control function (PCF), an authentication server function (AUSF), a network repository function (NRF), and other application functions (AFs). In one example, any one or more of cell sites 121-124 may comprise 2G, 3G, 4G and/or LTE radios, e.g., in addition to 5G new radio (NR), or gNB functionality. For instance, cell site 123 is illustrated as being in communication with AMF 135 in addition to MME 131 and SGW 132. Thus, these and other modifications are all contemplated within the scope of the present disclosure.

To further aid in understanding the present disclosure, FIG. 2 illustrates a flowchart of an example method 200 for prioritizing spectrum efficiency over buffer-based multiple input, multiple output communications, in accordance with the present disclosure. In one example, the method 200 may be performed by an application server that is configured to prioritize MU-MIMO communications over SU-MIMO communications for improved throughput and latency, such as the AS 195 illustrated in FIG. 1. However, in other examples, the method 200 may be performed by another device, such as the processor 502 of the system 500 illustrated in FIG. 5. For the sake of example, the method 200 is described as being performed by a processing system.

The method 200 begins in step 202. In step 204, the processing system may detect a presence of a plurality of user devices in a cell of a mobile network, wherein each user device of the plurality of user devices includes a buffer of a plurality of buffers, and wherein a fill level of at least one buffer of the plurality of buffers is less than one hundred percent.

The plurality of user devices may include cellular telephones, smartphones, tablet computing devices, laptop computers, pairs of computing glasses, wireless enabled wristwatches, wireless transceivers for a fixed wireless broadband (FWB) deployment, or any other cellular-capable mobile telephony and computing devices (broadly, “endpoint devices”). For instance, at least some of the user devices in the cell may include one or more RF transceivers for cellular communications and/or for non-cellular wireless communications. In one example, at least some of the user devices in the cell may be equipped with one or more directional antennas, or antenna arrays (e.g., having a half-power azimuthal beamwidth of 120 degrees or less, 90 degrees or less, 60 degrees or less, etc.), e.g., MIMO antenna(s) to receive and/or to transmit multi-path and/or spatial diversity signals.

Each user device of the plurality of user devices includes a respective buffer of the plurality of buffers. The buffers of the plurality of buffers do not all necessarily need to be of the same size or be capable of holding the same amount of data. Each buffer of the plurality of buffers has a respective fill level, where the fill level indicates a utilization of the corresponding buffer (e.g., how “full” the corresponding buffer is). In one example, at least one buffer of the plurality of buffers has a fill level that is less than one hundred percent. In other words, the at least one buffer is not full, and has some amount of unused space. In some examples, some buffers of the plurality of buffers may have fill levels that are one hundred percent, or none of the buffers of the plurality of buffers may have fill levels that are one hundred percent; however, at least one buffer of the plurality of buffers will have a fill level that is less than one hundred percent.

In step 206, the processing system may determine whether a spatial separation between the plurality of user devices meets a threshold spatial separation required to support multiple-user multiple input, multiple output communications and the spectrum efficiency for multiple user multiple input, multiple output communications is higher than the spectrum efficiency for single-user multiple input, multiple output communications.

As discussed above, one condition for supporting MU-MIMO communications requires sufficient spatial separation between the user devices for which MU-MIMO is activated. As discussed above, “sufficient” separation within this context is understood to comprise at least approximately fifteen degrees of angular separation on the horizontal direction for downlink (uplink typically does not require separation).

Furthermore, the processing system may evaluate the current spectrum efficiency of both MU-MIMO and SU-MIMO in the mobile network. If the current spectrum efficiency of MU-MIMO in the mobile network is greater than the current spectrum efficiency of SU-MIMO in the mobile network, then the processing system may determine that MU-MIMO communications should be activated under conditions where SU-MIMO communications would normally be activated (as long as sufficient spatial separation between the plurality of user devices exists, and regardless of the fill levels of the buffers of the plurality of user devices).

If the processing system concludes in step 206 that the spatial separation between the plurality of user devices meets the threshold spatial separation required to support multiple-user multiple input, multiple output communications and the spectrum efficiency for multiple user multiple input, multiple output communications is higher than the spectrum efficiency for single-user multiple input, multiple output communications, then the method 200 may proceed to step 208. In step 208, the processing system may activate multiple-user multiple input, multiple output communications in the cell for the plurality of user devices.

Thus, the processing system may activate MU-MIMO communications for the plurality of user devices, even though the buffer fill level for at least one of the plurality of user devices is not one hundred percent. In other words, even though the spatial separation required to support MU-MIMO communications has been met, the buffer utilization that is conventionally required has not been met. Despite this, MU-MIMO communications will be activated for all user devices in the plurality of user devices, regardless of buffer utilization.

In one example, activation of MU-MIMO communications in the absence of full buffers for all user devices may be facilitated by lowering the threshold buffer utilization that triggers activation of MU-MIMO communications. For instance, if the default buffer utilization threshold to trigger activation of MU-MIMO communications is one hundred percent for all user devices, then the default buffer utilization threshold may be lowered to a threshold that is less than one hundred percent, so that activation of MU-MIMO communications may be triggered even when all of the user devices do not have full buffers.

In another example, where the plurality of user devices are currently utilizing services that are not sensitive to delay (e.g., latency does not noticeably affect quality of experience for most users), the sizes of the plurality of buffers may be increased so that more data may accumulate in the buffers. This may cause buffers that are not full to become full, thereby triggering activation of MU-MIMO communications according to conventional requirements.

In one example, the MU-MIMO communications may be activated in the cell by sending an instruction to one or more base stations serving the cell, where the instruction instructs a base station to modify its configuration to enable MU-MIMO communications for the plurality of user devices. In another example, the MU-MIMO communications may be activated by sending an instruction to one or more of the user devices in the plurality of user devices, where the instruction instructs a user device to modify its configuration to enable MU-MIMO communications. For instance, instructions sent to a base station and/or a user device may request that the parameters (e.g., strength and/or direction of signal reception and/or transmission) of one or more antennas at the base station and/or user device be adjusted to support MU-MIMO communications.

Having activated MU-MIMO communications in the cell for the plurality of user devices, the method 200 may return to step 206, and the processing system may continue as described above to monitor the spatial separation between the plurality of user devices to ensure that the threshold spatial separation required to support MU-MIMO conditions is maintained.

If, however, the processing system concludes in step 206 that the spatial separation between the plurality of user devices does not meet the threshold spatial separation to support multiple-user multiple input or the spectrum efficiency for multiple user multiple input, multiple output communications is not higher than the spectrum efficiency for single-user multiple input, multiple output communications, multiple output communications, then the method 200 may proceed to step 210. In step 210, the processing system may activate single-user multiple input, multiple output communications in the cell for the plurality of user devices.

In one example, the SU-MIMO communications may be activated in the cell by sending an instruction to one or more base stations serving the cell, where the instruction instructs a base station to modify its configuration to enable SU-MIMO communications for the plurality of user devices. In another example, the SU-MIMO communications may be activated by sending an instruction to one or more of the user devices in the plurality of user devices, where the instruction instructs a user device to modify its configuration to enable SU-MIMO communications. For instance, instructions sent to a base station and/or a user device may request that the parameters (e.g., strength and/or direction of signal reception and/or transmission) of one or more antennas at the base station and/or user device be adjusted to support SU-MIMO communications.

Thus, steps 204-210 may be repeated periodically. This ensures that as the spatial separation between the plurality of user devices changes (e.g., as the plurality of user devices move within the cell, leave the cell, or as new user devices enter the cell), the cell resources can be optimally activated and distributed to provide the best possible throughput for all user devices.

Having activated SU-MIMO communications in the cell for the plurality of user devices, the method 200 may return to step 206, and the processing system may continue as described above to monitor the spatial separation between the plurality of user devices to detect whether the spatial separation between the plurality of user devices increases to the threshold spatial separation required to support MU-MIMO conditions. If the spatial separation between the plurality of user devices does at some point increase to the threshold spatial separation required to support MU-MIMO conditions, then the processing system may activate MU-MIMO communications in the cell for the plurality of user devices per step 208.

Although not expressly specified above, one or more steps of the method 200 may include a storing, displaying and/or outputting step as required for a particular application. In other words, any data, records, fields, and/or intermediate results discussed in the method can be stored, displayed and/or outputted to another device as required for a particular application. Furthermore, operations, steps, or blocks in FIG. 2 that recite a determining operation or involve a decision do not necessarily require that both branches of the determining operation be practiced. In other words, one of the branches of the determining operation can be deemed as an optional step. However, the use of the term “optional step” is intended to only reflect different variations of a particular illustrative embodiment and is not intended to indicate that steps not labelled as optional steps to be deemed to be essential steps. Furthermore, operations, steps or blocks of the above described method(s) can be combined, separated, and/or performed in a different order from that described above, without departing from the examples of the present disclosure.

Thus, examples of the present disclosure improve spectrum efficiency and increase average throughput (per-user and overall) for a wireless cell, while decreasing delay.

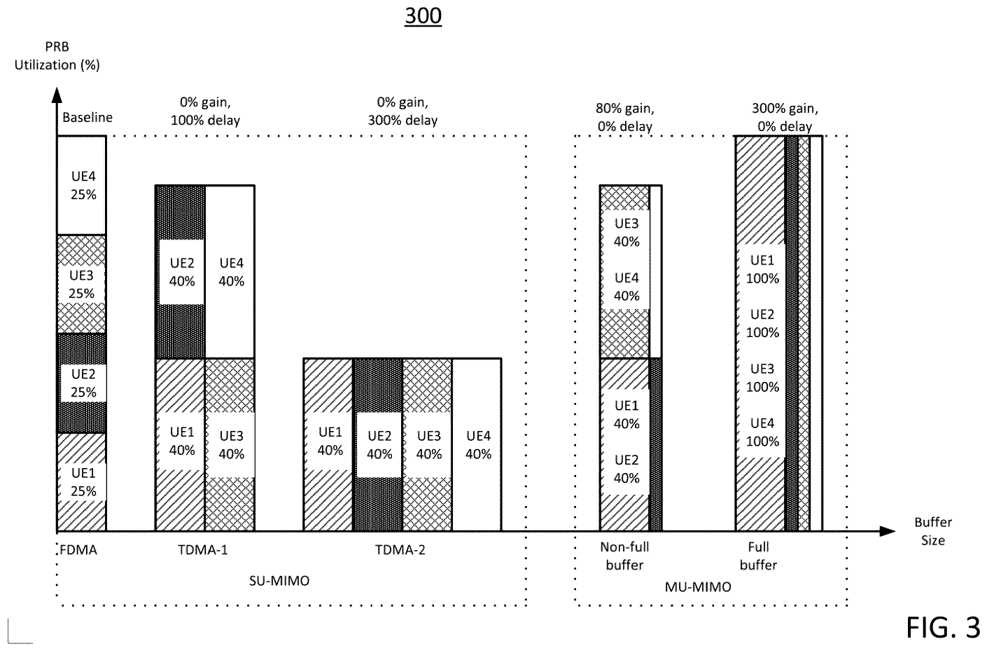

For instance, FIG. 3 illustrates a chart 300 showing one non-limiting example of how gain can be increased and delay decreased when activating multiple-user multiple input, multiple output communications in a situation where single-user multiple input, multiple output communications would normally be activated.

In particular, the chart 300 plots buffer fill level (e.g., PRB utilization %) versus buffer size for a group of four user devices, UE1, UE2, UE3, and UE4. The results of activating SU-MIMO are shown in the left for frequency division multiple access (FDMA) mode, TDMA-1 mode, and TDMA-2 mode. For FDMA mode, all of the user devices UE1-UE4 send data through a single communication channel, so the buffer fill level for each user device of UE1-UE4 is at no more than approximately twenty-five percent.

In TDMA-1 mode, the single communication channel may be divided into two time slots. Two of the user devices (e.g., UE1 and UE2) may share one of the time slots, while the other two user devices (e.g., UE3 and UE4) may share the other time slot. This allows the buffer fill level for each user device of UE1-UE4 to increase to up to approximately forty percent. However, the delay has now increased by approximately one hundred percent as compared to FDMA, because the number of time slots is doubled. The gain is zero percent.

In TDMA-2 mode, the single communication channel may be divided into four time slots, so that each user device of UE1-UE4 is assigned a separate time slot. This allows the buffer fill level for each user device of UE1-UE4 to increase to up to approximately forty percent. However, this increases the delay by approximately three hundred percent as compared to FDMA, because the number of time slots is quadrupled.

By contrast, MU-MIMO for the same four user devices of UE1-UE4 with non-full buffers may allow two user devices (e.g., UE1 and UE2; or UE3 and UE4) to share communication channels and time slots. This allows the buffer fill level for each user device of UE1-UE4 to be approximately forty percent, while still resulting in a gain of approximately eighty percent and zero or minimal delay.

MU-MIMO for the same four user devices UE1-UE4 with full buffers may allow all of the user devices UE1-UE4 to share a single communication channel and time slot. This allows the buffer fill level for each user device of UE1-UE4 to be approximately one hundred percent, while still resulting in a gain of approximately three hundred percent and zero or minimal delay.

Thus, as FIG. 3 illustrates, examples of the present disclosure allow a greater number of user devices to be scheduled for simultaneous data transmission, thereby increasing the total cell throughput while reducing latency. The increased spectrum reuse through MU-MIMO also increases spectrum efficiency.

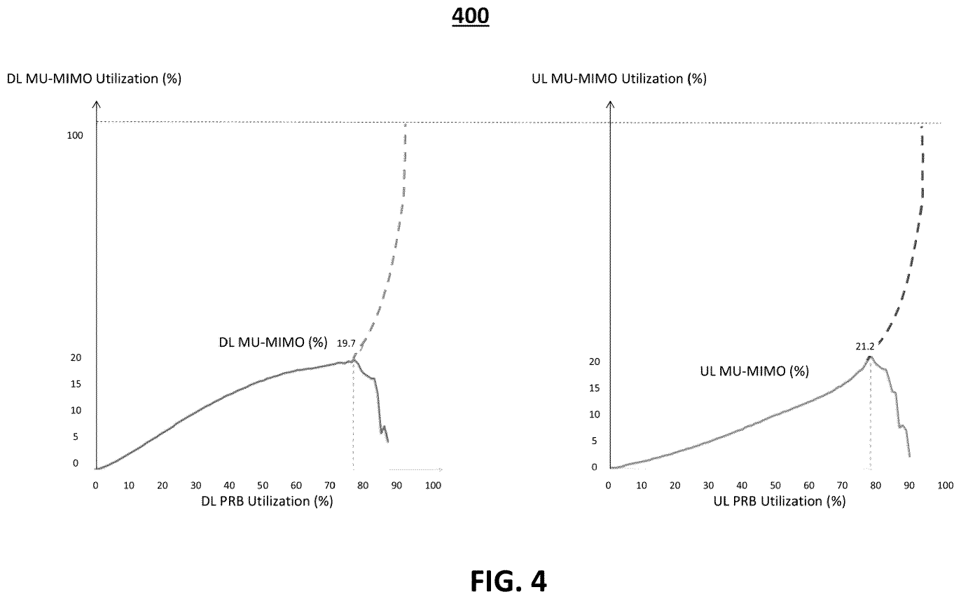

FIG. 4 illustrates a chart 400 showing one example of how examples of the present disclosure may increase MIMO utilization for both downlink and uplink transmissions. As illustrates in FIG. 4, MIMO utilization may increase to approximately one hundred percent from the twenty percent that is typical under approaches that favor SU-MIMO over MU-MIMO. This estimate is grounded in the fact that most real-world use cases do not employ full data buffers under average radio conditions.

FIG. 5 depicts a high-level block diagram of a computing device specifically programmed to perform the functions described herein. For example, any one or more components or devices illustrated in FIG. 1 or described in connection with the method 200 may be implemented as the system 500. For instance, an application server (such as might be used to perform the method 200) could be implemented as illustrated in FIG. 5.

As depicted in FIG. 5, the system 500 comprises a hardware processor element 502, a memory 504, a module 505 for prioritizing spectrum efficiency over buffer-based multiple input, multiple output communications, and various input/output (I/O) devices 506.

The hardware processor 502 may comprise, for example, a microprocessor, a central processing unit (CPU), or the like. The memory 504 may comprise, for example, random access memory (RAM), read only memory (ROM), a disk drive, an optical drive, a magnetic drive, and/or a Universal Serial Bus (USB) drive. The module 505 for prioritizing spectrum efficiency over buffer-based multiple input, multiple output communications may include circuitry and/or logic for prioritizing MU-MIMO communications under conditions that would normally trigger activation of SU-MIMO communications. The input/output devices 506 may include, for example, a camera, a video camera, storage devices (including but not limited to, a tape drive, a floppy drive, a hard disk drive or a compact disk drive), a receiver, a transmitter, a speaker, a display, a speech synthesizer, an output port, and a user input device (such as a keyboard, a keypad, a mouse, and the like), or a sensor.

Although only one processor element is shown, it should be noted that the computer may employ a plurality of processor elements. Furthermore, although only one computer is shown in the Figure, if the method(s) as discussed above is implemented in a distributed or parallel manner for a particular illustrative example, i.e., the steps of the above method(s) or the entire method(s) are implemented across multiple or parallel computers, then the computer of this Figure is intended to represent each of those multiple computers. Furthermore, one or more hardware processors can be utilized in supporting a virtualized or shared computing environment. The virtualized computing environment may support one or more virtual machines representing computers, servers, or other computing devices. In such virtualized virtual machines, hardware components such as hardware processors and computer-readable storage devices may be virtualized or logically represented.

It should be noted that the present disclosure can be implemented in software and/or in a combination of software and hardware, e.g., using application specific integrated circuits (ASIC), a programmable logic array (PLA), including a field-programmable gate array (FPGA), or a state machine deployed on a hardware device, a computer or any other hardware equivalents, e.g., computer readable instructions pertaining to the method(s) discussed above can be used to configure a hardware processor to perform the steps, functions and/or operations of the above disclosed method(s). In one example, instructions and data for the present module or process 505 for prioritizing spectrum efficiency over buffer-based multiple input, multiple output communications (e.g., a software program comprising computer-executable instructions) can be loaded into memory 504 and executed by hardware processor element 502 to implement the steps, functions or operations as discussed above in connection with the example method 200. Furthermore, when a hardware processor executes instructions to perform “operations,” this could include the hardware processor performing the operations directly and/or facilitating, directing, or cooperating with another hardware device or component (e.g., a co-processor and the like) to perform the operations.

The processor executing the computer readable or software instructions relating to the above described method(s) can be perceived as a programmed processor or a specialized processor. As such, the present module 505 for prioritizing spectrum efficiency over buffer-based multiple input, multiple output communications (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette and the like. More specifically, the computer-readable storage device may comprise any physical devices that provide the ability to store information such as data and/or instructions to be accessed by a processor or a computing device such as a computer or an application server.

While various examples have been described above, it should be understood that they have been presented by way of example only, and not limitation. Thus, the breadth and scope of a preferred example should not be limited by any of the above-described example examples, but should be defined only in accordance with the following claims and their equivalents.

What is claimed is:

1. A method comprising:
detecting, by a processing system including at least one processor, a presence of a plurality of user devices in a cell of a mobile network, wherein each user device of the plurality of user devices includes a buffer of a plurality of buffers, and wherein a fill level of at least one buffer of the plurality of buffers is less than one hundred percent;
determining, by the processing system, that a spatial separation between the plurality of user devices meets a threshold spatial separation required to support multiple user multiple input, multiple output communications and that a spectrum efficiency for multiple-user multiple input, multiple output communications is higher than a spectrum efficiency for single-user multiple input, multiple output communications; and
activating, by the processing system, multiple-user multiple input, multiple output communications in the cell for the plurality of user devices.

2. The method of claim 1, wherein the processing system is part of a base station that serves the cell.

3. The method of claim 2, wherein the base station is equipped with a multiple input, multiple output antenna.

4. The method of claim 1, wherein the threshold spatial separation is at least fifteen degrees of angular separation on a horizontal direction for downlink.

5. The method of claim 1, wherein the activating comprises lowering a threshold buffer utilization that triggers activation of the multiple-user multiple input, multiple output communications from a default threshold to a new threshold that is lower than the default threshold.

6. The method of claim 5, wherein the default threshold is one hundred percent.

7. The method of claim 1, wherein the activating comprises increases sizes of the plurality of buffers so that more data accumulates in the plurality of buffers.

8. The method of claim 1, wherein the activating comprises determining that a current spectrum efficiency of the multiple user multiple input, multiple output communications in the cell is greater than a current spectrum efficiency of single multiple user multiple input, multiple output communications.

9. The method of claim 1, further comprising:
determining, by the processing system after the activating, that the spatial separation between the plurality of user devices no longer meets the threshold spatial separation required to support the multiple-user multiple input, multiple output communications; and
activating, by the processing system, single-user multiple input, multiple output communications in the cell for the plurality of user devices.

10. A non-transitory computer-readable medium storing instructions which, when executed by a processing system including at least one processor, cause the processing system to perform operations, the operations comprising:
detecting a presence of a plurality of user devices in a cell of a mobile network, wherein each user device of the plurality of user devices includes a buffer of a plurality of buffers, and wherein a fill level of at least one buffer of the plurality of buffers is less than one hundred percent;
determining that a spatial separation between the plurality of user devices meets a threshold spatial separation required to support multiple user multiple input, multiple output communications and that a spectrum efficiency for multiple-user multiple input, multiple output communications is higher than a spectrum efficiency for single-user multiple input, multiple output communications; and
activating multiple-user multiple input, multiple output communications in the cell for the plurality of user devices.

11. The non-transitory computer-readable medium of claim 10, wherein the threshold spatial separation is at least fifteen degrees of angular separation on a horizontal direction for downlink.

12. The non-transitory computer-readable medium of claim 10, wherein the activating comprises lowering a threshold buffer utilization that triggers activation of the multiple-user multiple input, multiple output communications from a default threshold to a new threshold that is lower than the default threshold.

13. The non-transitory computer-readable medium of claim 12, wherein the default threshold is one hundred percent.

14. The non-transitory computer-readable medium of claim 10, wherein the activating comprises increases sizes of the plurality of buffers so that more data accumulates in the plurality of buffers.

15. The non-transitory computer-readable medium of claim 10, wherein the activating comprises determining that a current spectrum efficiency of the multiple user multiple input, multiple output communications in the cell is greater than a current spectrum efficiency of single multiple user multiple input, multiple output communications.

16. The non-transitory computer-readable medium of claim 10, the operations further comprising:
determining, after the activating, that the spatial separation between the plurality of user devices no longer meets the threshold spatial separation required to support multiple-user multiple input, multiple output communications; and
activating single-user multiple input, multiple output communications in the cell for the plurality of user devices.

17. A device comprising:
a processing system including at least one processor; and
a computer-readable medium storing instructions which, when executed by the processing system, cause the processing system to perform operations, the operations comprising:
detecting a presence of a plurality of user devices in a cell of a mobile network, wherein each user device of the plurality of user devices includes a buffer of a plurality of buffers, and wherein a fill level of at least one buffer of the plurality of buffers is less than one hundred percent;
determining that a spatial separation between the plurality of user devices meets a threshold spatial separation required to support multiple user multiple input, multiple output communications and that a spectrum efficiency for multiple-user multiple input, multiple output communications is higher than a spectrum efficiency for single-user multiple input, multiple output communications; and
activating multiple-user multiple input, multiple output communications in the cell for the plurality of user devices.

18. The device of claim 17, wherein the activating comprises lowering a threshold buffer utilization that triggers activation of the multiple-user multiple input, multiple output communications from a default threshold to a new threshold that is lower than the default threshold.

19. The device of claim 17, wherein the activating comprises increases sizes of the plurality of buffers so that more data accumulates in the plurality of buffers.

20. The device of claim 17, wherein the activating comprises determining that a current spectrum efficiency of the multiple user multiple input, multiple output communications in the cell is greater than a current spectrum efficiency of single multiple user multiple input, multiple output communications.
